(19) United States
(12) Patent Application Publication
(10) Pub. No.: US 2016/0092944 A1
(43) Pub. Date: Mar. 31, 2016

(54) PROXIMITY ALERTS FOR SERVICE RESOURCE AVAILABILITY

(71) Applicant: WAL-MART STORES, INC., Bentonville, AR (US)

(72) Inventors: Joseph D. Taylor, Pullman, WA (US); Richard M. Blair, II, Centerton, AR (US); William Ross Allen, Bentonville, AR (US)

(21) Appl. No.: 14/862,474

(22) Filed: Sep. 23, 2015

Related U.S. Application Data
(60) Provisional application No. 62/055,941, filed on Sep. 26, 2014.

(51) Int. Cl. G06Q 30/02; G06Q 50/10; G06Q 10/02; H04W 4/02

(52) U.S. Cl. CPC G06Q 30/0281; H04W 4/021; G06Q 50/10; G06Q 10/02

(57) ABSTRACT

Provided are a system and method of electronic notification of an availability of a service resource. A signal is received from a sensor indicating that a customer has entered a region proximate to a store. The customer is determined to be a candidate for a service. A service resource is determined to be available at or near the store for performing the service. A notification is sent to a display of the availability of the service resource.

### RELATED APPLICATIONS

This application claims priority to U.S. Patent Application Ser. No. 62/055,941 filed on Sep. 26, 2015 and entitled, “PROXIMITY ALERTS FOR SERVICE RESOURCE AVAILABILITY”, which is incorporated herein by reference in its entirety.

### FIELD OF THE INVENTION

The invention relates generally to appointment systems and methods, and more specifically, to systems and methods for notifying a customer of the availability of a facility or other resource for performing a service for the customer.

### BACKGROUND

Automobiles are periodically taken to a vehicle service provider for performing a service such as an oil change, tire rotation, and so on. Unless a customer schedules an appointment in advance, the customer will typically wait at the service provider until a bay or related facility becomes available.

### BRIEF SUMMARY

In one aspect, provided is a method of electronic notification of an availability of a service resource, comprising: receiving by a special purpose computer a signal from a sensor indicating by a special purpose computer that a customer has entered a region proximate to a store; determining in response to the received signal that the customer is a candidate for a service; determining by a special purpose computer that a service resource is available at or near the store for performing the service; and sending by a special purpose computer a notification to a display of the availability of the service resource.

In another aspect, provided is a system for notification of an availability of a service resource, comprising: a location determination module that receives a signal indicating that a customer has entered a region proximate to a store; a registration module that determines that the customer is a candidate for a service; a resource determination module that determines that a service resource is available at or near the store for performing the service; and a notification module that sends a notification to the customer of the availability of the service resource.

In another aspect, provided is a computer program product for electronic notification of an availability of a service resource. The computer program product comprises a non-transitory computer readable storage medium having computer readable program code embodied therewith. The computer readable program code comprises computer readable program code configured to receive from a sensor a signal indicating that a customer has entered a region proximate to a store; computer readable program code configured to determine in response to the received signal that the customer is a candidate for a service; computer readable program code configured to determine that a service resource is available at or near the store for performing the service; and computer readable program code configured to send a notification to a display of the availability of the service resource.

### BRIEF DESCRIPTION OF THE SEVERAL VIEWS OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a perspective view of a geofenced area at which embodiments of the present inventive concepts are employed.

FIG. 2 is a flowchart of a method of notification of an availability of a service facility, in accordance with some embodiments.

FIG. 3 is an illustration of a process for generating proximity alerts of an availability of a service, in accordance with some embodiments.

FIG. 4 is a schematic view illustrating a system for matching an available service with a customer requirement, in accordance with some embodiments.

FIG. 5 is a flowchart of a method of notification of an availability of a service facility, in accordance with some embodiments.

### DETAILED DESCRIPTION

Embodiments of systems and methods described herein apply to a service, for example, a vehicle service such as an oil change, tire rotation, and/or battery replacement service. Other services may include but not be limited to dentistry, routine doctor visit, haircut, bank activity, and so on. A customer receives an electronic notification at a smartphone or related electronic device that a service resource is available, for example, a garage bay, dentist chair, barber seat, bank teller window, and so on either immediately or at a predetermined time in the future. The notification can include a recommendation that the customer can receive a service, and is determined by three data points. First, the customer is due for the service, for example, according to a predetermined schedule such as the number of miles since the last oil change. Second, the customer is in the vicinity of the store, for example, the store's parking lot. Third, the store has an available resource to perform the service. For example, the garage for performing an oil change has a bay that is currently available. Thus, a customer is matched with an available service based on the customer's proximity to the location of the service facility and also on a determination that the customer may need the service. For example, the customer may receive a notification when the customer's vehicle has reached a predetermined mileage or time threshold since the last performed service, or when the customer is due for a haircut or dentist appointment. The customer can choose whether to respond to the notification, for example, to accept an invitation to have the service performed at the facility at the time identified in the notification. Accordingly, wait times can be reduced or eliminated.

Accordingly, features of the inventive concepts offer the ability to match an available service with a customer need to provide a service alert and appointment system.

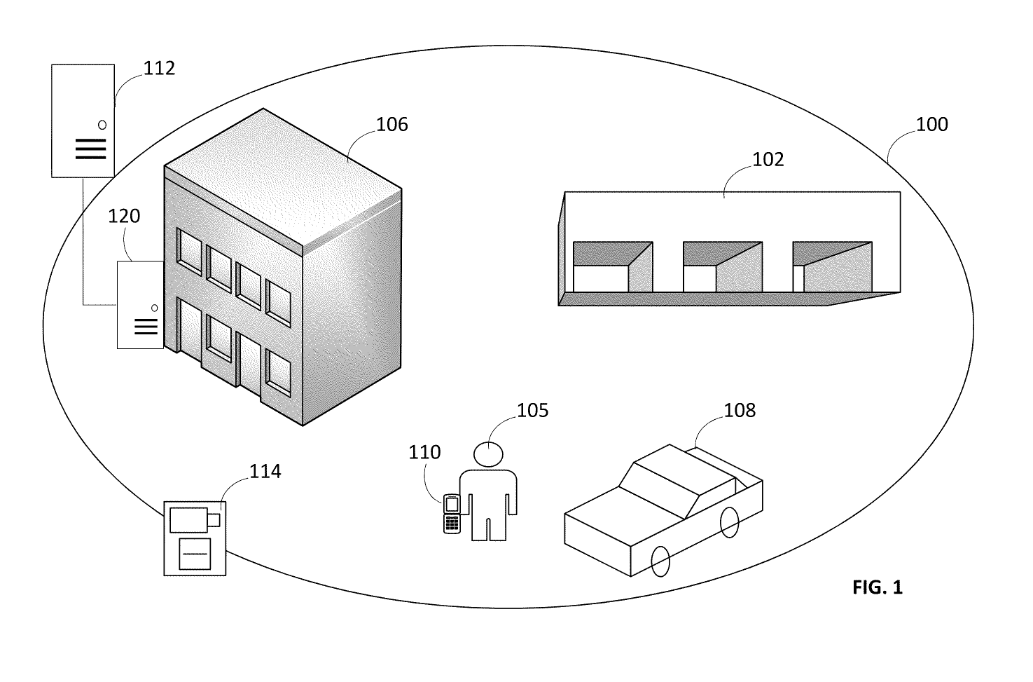

FIG. 1 is a perspective view of a geofenced area 100 at which embodiments of the present inventive concepts are employed.

A geofenced area 100 can surround an area of interest of practically any size. The geofenced area 100 can be defined by Global Positioning System (GPS) coordinates, which define a perimeter or boundary surrounding a geographic region in which the service facility 102 and a retail store 106 are located. The geofenced area 100 can include a monitoring system 114 comprising sensors or the like that detect a presence of a person 105 at or near the geofenced area 100, or the person's mobile device 110, vehicle 108, and/or other device, which outputs a GPS signal, radio-frequency identification (RFID) tag, or related signal that can be received by the monitoring system 114. Other location identification systems can equally apply, such as a cell tower, wireless (WiFi) triangulation, iBeacons, or the like for identifying the location passively. Alternatively, a location can be determined when the customer actively logs into the store network. The monitoring system 114 can provide detection-related information, such as a timestamp, location, and so on to a backend server 112 for processing.

The backend server 112 includes a hardware processor that determines whether the person 105 in the geofenced area 100 is a customer who may be a candidate for a service, such as a vehicle oil change, a haircut, a dentist visit, or other service known to those of ordinary skill in the art. For example, information can be output from the mobile device 110 to the backend server 112 that identifies the person 105 as a customer registered with the website of the store 106. The customer 105 can be deemed a candidate for a service from data regarding the customer 105 stored at a database, for example, information indicating that the customer received a haircut one month ago and is due for another haircut, or that the customer's vehicle 108 received an oil change 3 months ago and is due for a new oil change.

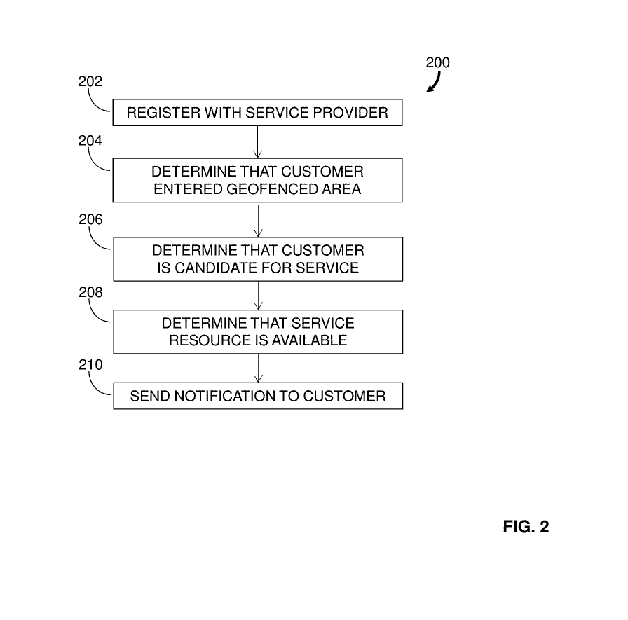

FIG. 2 is a flowchart of a method 200 of notification of an availability of a service facility, in accordance with some embodiments. In describing the method 200, reference is made to elements of FIG. 1. One or more steps of the method 200 are executed by special purpose computers, for example, described herein.

At block 202, a current or potential customer 105 can register with a service provider. The service provider may offer a service that requires an allocated resource in order to perform the service. For example, the service provider may offer a vehicle service such as an oil change, tire rotation, battery replacement, tune-up, and so on, but is not limited thereto, that requires the availability of a garage bay to perform the vehicle service.

The customer can register with a service provider by entering personal data via the service provider's website, or by completing an online or paper form. The user's registration data is stored at a database or other repository, for example, at store computer 120 that communicates with the backend server 112. In doing so, the customer 105 can receive notifications at the mobile device 110 or other electronic device, such as appointment reminders, bulletins, advertisements, and so on.

At block 204, a determination is made that the customer 105 has entered the geofenced area 100. The monitoring system 114 can receives a signal, for example, from a location-aware device, for example, the customer's mobile device 110, when the customer enters the geofenced area 100. The monitoring system 114 can, in turn, send a notification to the backend server 112 of the customer's presence at or near the geofenced area 100.

At block 206, a determination is made that the customer 105 is a candidate for a service. The backend server 112 can determine from the registered customer's data whether the customer is due for a service such as a haircut, tire rotation, or other service.

At block 208, a determination is made that a service resource is available. For example, the service facility 102 can include a computer that generates a message that is output to the backend server 112 when a garage bay, dentist chair, or other resource is available

At block 210, a special purpose computer generates a notification, which is output to the customer, more specifically, an electronic device such as a smartphone that can receive the electronic notification that the service resource is available. The backend server 112 can determine from data received the store computer 120 and/or service facility 102 that the customer is a candidate for a service, and also determine that a service facility resource is available for performing the service.

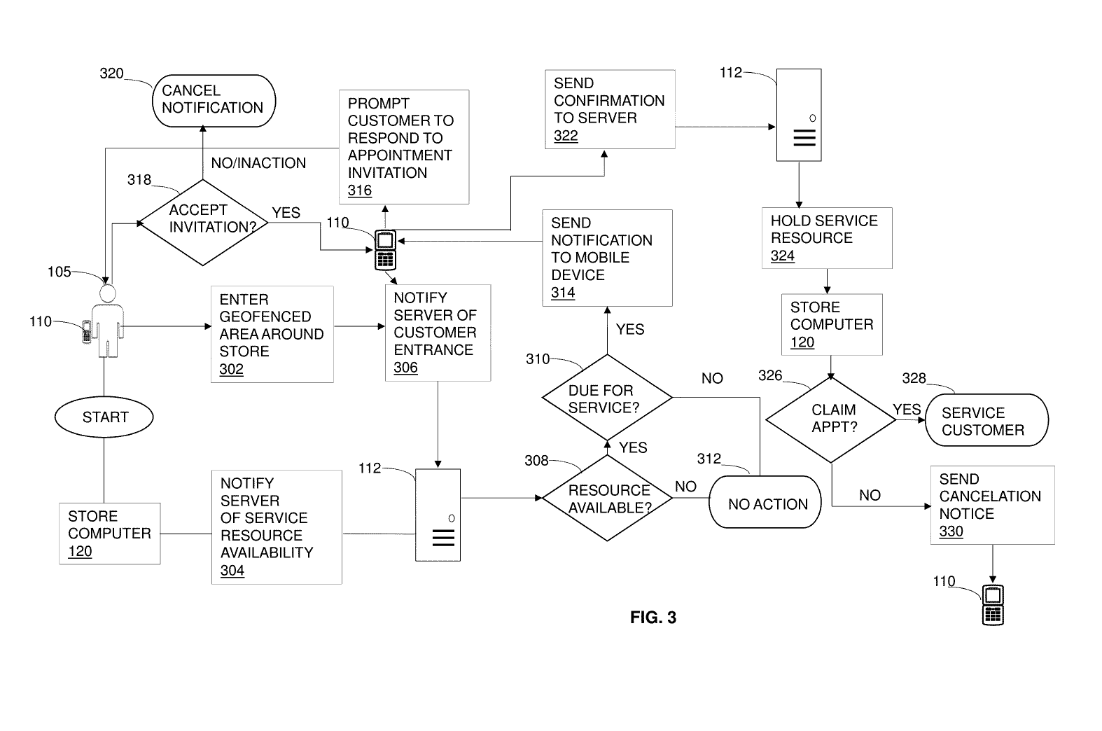

FIG. 3 is an illustration of a process for generating proximity alerts of an availability of a service, in accordance with some embodiments. In describing the process, reference can be made to elements of FIGS. 1 and/or 2.

The process starts with two events, which may occur in no particular order. The first event is described at block 302, at which a customer 105 enters a geofenced area 100 at which a service can be provided. The customer 105 possesses a mobile device 110 or other device configured to send a signal to a geofence monitoring system sensor 114 or the like regarding the presence of the customer 105 at the geofenced area 100. The sensor 114 can include a security camera or the like positioned about the geofenced area 100 that detects the presence of the customer 105.

The second event is described at block 304, where a store computer 120 notifies the backend server 112 or related processor that a service facility resource, for example, an open bay 102, has become available. The store computer 120 can be inside the geofenced area 100, for example, inside the store 106. Alternatively, the store computer 120 can be external to the geofenced area 100. The backend server 112 or the like can include a queue or related storage configuration for adding this information for future retrieval.

At block 306, the mobile device 110 sends a notification to the backend server 112 that the customer has entered the geofenced area 100. Here, a software application executed on the mobile device 110 or other computer configured with a GPS tracking device tracks the location of the device 110, for example, to establish when the mobile device 110, and therefore the customer in possession of the mobile device 110, is at or inside the geofenced area 100.

At decision diamond 308, a determination is made whether a service facility resource is available for the customer. For example, a service facility resource such as a garage bay 102 for the customer's car can be determined to be available by the store computer 120 which at block 306 notifies the backend server 112. No action is taken (see block 312) if a determination is made that a service facility resource is not available. Otherwise, the process proceeds to decision diamond 310.

The store computer 120 can also store a customer's service history, for example, recent oil changes, haircuts, etc. Accordingly, at decision diamond 310, the interaction of an output of the store computer 120 and detection data related to a signal received by the monitoring system 114 permits a determination to be made from this data and/or other information accessible by the backend server 112 whether the customer is due for service, for example, due for an oil change, haircut, or other service. No action is taken (see block 312) if a determination is made that the customer is not due for the service. Otherwise, the process proceeds to block 314, where a notification is sent to the mobile device 110 and/or other electronic device constructed to receive a communication for the customer 105 when a determination is made that the service facility resource is available and that the customer is due for the service, which the system can verify against a stored service history at the backend server 112 or other storage device in communication with the backend server 112.

The notification can include a request to accept or decline the invitation for the provider to perform the service. Accordingly, at block 316, the customer 105 is prompted, for example, by a display request on the mobile device 110 or other electronic device having a display, speaker, or other communication device, to accept or decline the invitation (see decision diamond 318).

If the customer 105 accepts the invitation, for example, by replying to the invitation at the mobile device 110, then the method proceeds to block 322, where the mobile device 110 sends a confirmation to the server 112 to book the instant appointment. Otherwise, if the customer declines the invitation or fails to respond to the invitation within a predetermined time, then the notification is canceled (320) and the resource is not reserved for the customer.

At block 324, the resource is reserved for the customer 105. For example, the server 112 communicates with the store computer 120 or other processor having a scheduler or the like to create a predetermined allocation of the resource, for example, hold the bay 102 available for a predetermined time for the customer's vehicle 108. The store server 120 can schedule the availability of the car bay, dentist chair, or other resource for the customer 105 according to the appointment time and date. For example, if the customer 105 accepts the invitation, then a confirmation is sent to the backend server 112 to book an “instant appointment”. The server 112 will then communicate with the store computer 120 to create a predetermined hold, for example, 5 minutes, on the bay 102 for the customer's vehicle 108.

At decision diamond, a decision is made whether the customer 105 claims the instant appointment, for example, arrives with the vehicle 108 at the service facility garage bay 102 to receive the oil change or other vehicle service according to the instant appointment data, e.g., the date and time. If the customer arrives at the service location at the allotted time, then the customer receives the service (328). Otherwise, at block 330, a cancellation notice is generated and the resource is not reserved for the customer. The resource is returned to the queue for availability for another customer.

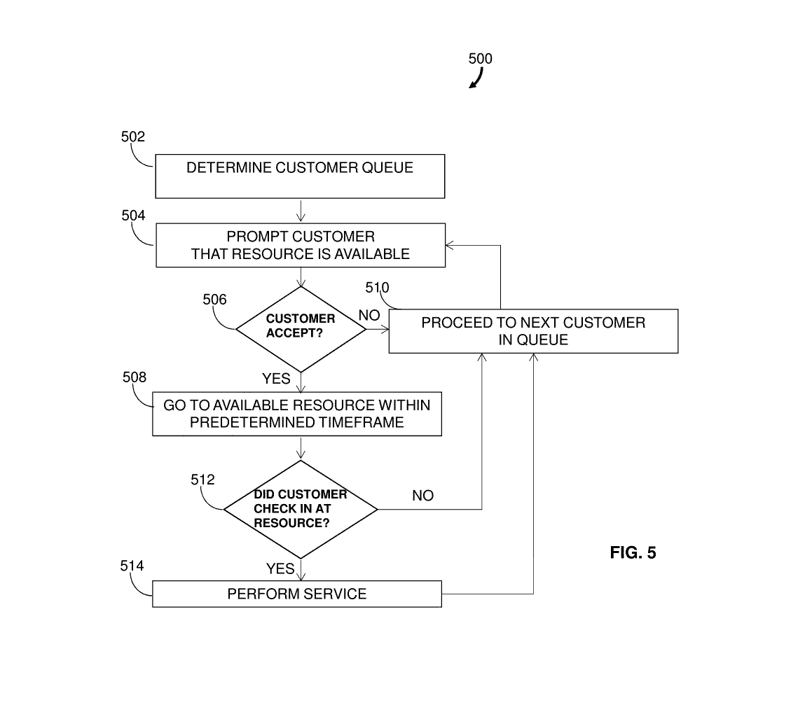

In some embodiments, a threshold can be provided to the backend server 112 or other processor that establishes a notification. For example, a user-related threshold can be established that the customer 105 is to receive a notification if there is less than a 30 minute wait for the oil change, or that the bay will be open in 30 minutes. The threshold can be user-defined, for example, as part of customer registration data described herein. In other embodiments, wait time data can be readily available for the customer 105, for example, provided at the store website or received as part of the notification. The wait time data can include a queue or list of other customers in the queue in front of the customer 105. Other embodiments are described with reference to FIG. 5. In some embodiments, the customer can set an individualized threshold for acceptable wait periods to receive a service.

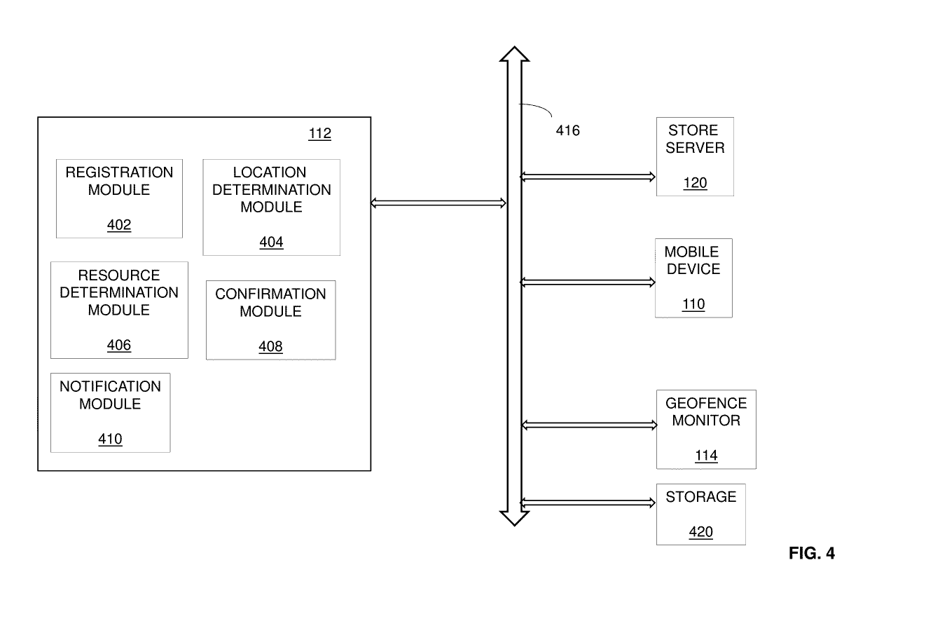

FIG. 4 is a schematic view illustrating a system 400 for matching an available service with a customer requirement, in accordance with some embodiments. The system 400 includes elements in the geofenced area 100 of FIG. 1, which perform some or all steps of the methods of FIGS. 2 and 3, respectively, including a backend server 112, store server 120, mobile device 110, geofence monitor 114, and a storage device 420 including a queue. Each of the backend server 112, store server 120, mobile device 110, geofence monitor 114, and queue 420 includes a processor and memory for executing some or all of the method steps of FIGS. 2 and 3, respectively.

Each of the backend server 112, store server 120, mobile device 110, geofence monitor 114, and queue 420 can communicate with each other via a data bus 416 or wired and/or wireless network. The data bus 416 can receive exchange via mobile or direct physical connections.

The backend server 112 includes a registration module 402, a location determination module 404, a resource determination module 406, a confirmation module 408, and notification module 410, which are stored in memory and executed by a hardware device including a processor. The registration module 402, location determination module 404, resource determination module 406, confirmation module 408, and notification module 410 can be at a same hardware platform, or at different devices.

The registration module 402 processes customer registration data, which can be provided for determining whether a customer requires a particular service, determining a time for performing the service, and so on. Accordingly, the registration module 402 can determine that a customer is a candidate for a service.

The location determination module 404 communicates with the mobile device 110 to determine and process information related to a current location of the mobile device 110. The location determination module 404 also communicates with the geofence monitor 114 to receive information regarding the detected presence of a person at or near the geofenced area 110. Information processed by the location determination module 404 includes timestamps, location, or other detection-related data. Alternatively, the location determination module 404 can directly or indirectly communicate with a vehicle, for example, via RFID or other detector to determine whether the vehicle has entered the region proximate the resource for allocation.

The resource determination module 406 processes data from the registration module 402, the location determination module 404, the store server 120, and/or the queue 420 to determine the availability of a service facility resource is in view of customer availability. Customer availability may be established from the registration module 402 and/or queue 420, which may include a list of available resources and/or a list of customers requiring access to the resource.

The confirmation module 408 processes a confirmation received to hold an available resource for use by a customer. The confirmation module 408 can include a timer that holds the resource available for a predetermined period of time. At the end of the predetermined period of time, the resource is returned to the queue 420 for open availability. In doing so, the confirmation module 408 can communicate with the store server 120, which includes scheduling data, customer information, and/or other data for reserving and allocating service resources, such as a vehicle bay 102.

The notification module 410 generates and outputs notifications to a display, such as the mobile device 110, including notifications that the customer is due for a service, the availability of a resource for the service, and so on. Other notifications can include cancellations of a scheduled service and so on, as described herein. The display can include a visual display and/or an audio display.

FIG. 5 is a flowchart of a method 500 of notification of an availability of a service facility, in accordance with some embodiments. Some or all of the method 500 can be executed at a processor, for example, backend server 112 described herein. The method 500 can be initiated when the customer 105 arrives at the geofenced area 100, for example, a parking lot or the retail store 106 in the geofenced area 100.

At block 502, an indication of the arrival of the customer can be placed in an intermediate arrival queue, for example, stored at a database 420 or other repository that communicates with the backend server 112. In some embodiments, customers are automatically placed in the queue. In other embodiments, customers receive a notification requesting whether they wish to be placed in the queue. Once placed in the queue, a customer may have a predetermined timeframe to remain in the queue.

At block 504, a customer 105 can receive a notification at the mobile device 110 that the service facility resource 102 is available and that the customer is due for the service, along with a request to accept or decline the invitation for the provider to perform the service.

At decision diamond 506, a determination is made whether the customer 105 accepts the invitation. The customer 105 may be expected to respond within a predetermined period of time, for example, 60 seconds. If customer accepts, i.e., by entering data into an electronic device 110 that communicates with relevant special purpose computers performing one or more steps of the method 400, within the predetermined period of time, then the method 500 proceeds to block 508 where the customer is expected to arrive at the assigned service facility 102 within a predetermined period of time. If at decision diamond 506, the customer declines the invitation or fails to respond within the predetermined period of time, e.g., 60 seconds, then the method 500 proceeds to block 510 where the system processes the next customer in the queue.

At decision diamond 512, a determination is made whether the customer 105 arrives at the service facility 102 within a predetermined period of time, for example, 5 minutes. If the customer 105 arrives in time, then the method 500 proceeds to block 514, where the service is performed at the available resource. Another timeframe, for example, 30-90 seconds, can be established to prevent customers from shopping or the like after the customer arrives, but before entering the door. Otherwise, the method 500 proceeds to block 510 where the system processes the next customer in the queue.

In other embodiments, related methods can be performed, for example, allowing a customer to set an individualized threshold for acceptable wait periods to receive a service. For example, a queue can be established for customers in the retail store 106. A customer may wish to purchase merchandise and wishes to check-out before taking the vehicle 108 to the garage 102, or a customer may wish to temporarily place their cart back near the facility 102, proceed to retrieve his/her car 108, drop it off, and continue to shop until time for pickup The method may include determining that a first customer is in the store prior to checkout, determining that a second customer is interested in a service resource, placing the second customer in a queue, and providing the service resource for the second customer prior to the first customer being available at the service resource.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, cloud-based infrastructure architecture, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the invention has been shown and described with reference to specific preferred embodiments, it should be understood by those skilled in the art that various changes in form and detail may be made therein without departing from the spirit and scope of the invention as defined by the following claims.

What is claimed is:

1. A method of electronic notification of an availability of a service resource, comprising:
receiving by a special purpose computer a signal from a sensor indicating that a customer has entered a region proximate to a store;
determining by a special purpose computer in response to the received signal that the customer is a candidate for a service;
determining by a special purpose computer that a service resource is available at or near the store for performing the service; and
sending by a special purpose computer a notification to a display of the availability of the service resource.

2. The method of claim 1, wherein the service includes an oil change, a tire change, a battery service, a tune-up, or a combination thereof.

3. The method of claim 1, wherein determining that the customer has entered a region proximate to the store comprises determining that the customer has entered a geofenced region about a perimeter of the store.

4. The method of claim 1, further comprising determining a current location of the customer by communicating with a mobile device with the customer.

5. The method of claim 1, wherein the notification is sent to the mobile device.

6. The method of claim 1, further comprising determining a current location of the customer by communicating with a vehicle of the customer to determine whether the vehicle has entered the region proximate to the store.

7. The method of claim 1, further comprising:
waiting, for a predetermined period of time, for the customer to respond to the notification whether to provide a vehicle to the available service facility; and
releasing the service facility for availability to other customers when the customer does not respond to the notification or responds to the notification after the predetermined period of time.

8. The method of claim 1, wherein the service facility is a garage bay.

9. The method of claim 1, wherein the availability is an immediate availability.

10. The method of claim 1, further comprising:
adding the customer to a queue;
sending the notification to the customer of the availability of the service resource when the customer is added to the queue; and
proceeding to a next customer in the queue in response to a determination that the customer does not reply to the notification within a predetermined period of time or that the customer does not arrive at the service resource within a predetermined period of time.

11. The method of claim 10, further comprising setting, by the customer, an individualized threshold for acceptable wait periods to receive a service.

12. A system for notification of an availability of a service resource, comprising:
a location determination module that receives a signal indicating that a customer has entered a region proximate to a store;
a registration module that determines that the customer is a candidate for a service;
a resource determination module that determines that a service resource is available at or near the store for performing the service; and
a notification module that sends a notification to the customer of the availability of the service resource.

13. The system of claim 12, further comprising a confirmation module that processes a confirmation to reserve the service resource for the customer.

14. The system of claim 13, wherein the confirmation module includes a timer that reserves the service resource for a predetermined period of time.

15. The system of claim 12, wherein the service includes an oil change, a tire change, a battery service, a tune-up, or a combination thereof.

16. The system of claim 12, wherein the location determination module determines that the customer has entered a geofenced region about a perimeter of the store.

17. The system of claim 12, wherein the notification module determines a current location of the customer by communicating with a mobile device with the customer

18. The system of claim 12, wherein the location determination module determines a current location of the customer by communicating with a vehicle of the customer to determine whether the vehicle has entered the region proximate to the store.

19. The system of claim 18, further comprising a queue that includes data related to an availability of a plurality of customers that are candidates for the availability of the service resource, and wherein a different customer is selected from the queue when the customer fails to respond to the notification or fails to arrive at the service resource within a predetermined period of time.

20. A computer program product for electronic notification of an availability of a service resource, the computer program product comprising:
a non-transitory computer readable storage medium having computer readable program code embodied therewith, the computer readable program code comprising:
computer readable program code configured to receive a signal from a sensor indicating that a customer has entered a region proximate to a store;
computer readable program code configured to determine in response to the received signal that the customer is a candidate for a service;
computer readable program code configured to determine that a service resource is available at or near the store for performing the service; and
computer readable program code configured to send a notification to a display of the availability of the service resource.
